(19) United States
(12) Patent Application Publication
(10) Pub. No.: US 2001/0025581 A1
(43) Pub. Date: Oct. 4, 2001

(54) Apparatus for correctly registering mounting of a printing plate

(76) Inventors: Arnfried Jehring, Coswig (DE); Christian Ziegenbalg, Weinbohla (DE); Ralf Zscheile, Friedenwald (DE); Andreas Techert, Coswig (DE)

Correspondence Address: Gabriel P. Katona L.L.P., 14th floor, 708 Third Avenue, New York, NY, 10017, US

(21) Appl. No.: 09/821,289

(22) Filed: Mar. 29, 2001

(30) Foreign Application Priority Data
Mar. 29, 2000 (DE) 100 15 728.9

(51) Int. Cl. B41F 21/12; B41F 1/34; B41L 47/14; B41F 27/12

(52) U.S. Cl. 101/415.1; 101/378; 101/477; 101/481

(57) ABSTRACT

The invention relates to an apparatus for correctly registering mounting of a printing plate. Task of the invention is to provide an apparatus to control the correctly registered position of a printing plate, which can be realized with simple means and can withstand abrupt load changes of the printing plate. The task is solved according the invention by inserts allocated to registering elements, which are contacting the printing plate electrically isolated from the registering elements and are connected to a control unit.

### FIELD OF INVENTION

The invention relates to an apparatus for correctly registering mounting of a printing plate on a plate cylinder of a sheet fed offset press. The plate cylinder has in the plate cylinder gap a plate clamping apparatus consisting of a front plate clamping device and a rear plate clamping and tensioning device. Registering elements for the lateral and circumferential direction are located in the front plate clamping device. These registering elements coinciding with the registering punches in the printing plate and are connected with a control unit.

### BACKGROUND OF INVENTION

An apparatus with electrically isolated registering pins at the front plate clamping device is known from DE-GM 77 28 905. The registering pins are connected with an electrical source and a signal transmitter. An electrical circuit is closed and the signal transmitter is activated when the registering pins contacting the printing plate in the registering holes.

It is disadvantageous that the signal transmitter is also activated if the printing plate is not correctly registered. This is for instance the case when deformations or too large tolerances in the registering hole are causing skewing of the printing plate. The signal transmitter is also activated if for instance the printing plate is laterally misaligned so that the registering pins are touching the front edge of the printing plate. Is also possible that the registering pins are not touching the bottom but the side of the U-shaped at the front edge open registering and an incorrectly registered printing plate activates the signal transmitter.

The apparatus according to EP 581 212 B1 eliminates these disadvantages. The registering pins are also electrically isolated and connected to an electrical source and a signal transmitter. The registering pins have an additional partial isolation on its surface that only a certain conductive section is detecting the bottom part of the registering hole. Disadvantage of the apparatus are the expensive manufactured registering pins. The isolated surface carries high loads and therefore either the surface or the entire registering pin are made from ceramics. This material can not withstand the occurring abrupt load changes, which might cause breakage of the registering pin.

### SUMMARY DESCRIPTION OF INVENTION

Task of the invention is to provide an apparatus to control the correctly registered position of a printing plate, which can be realized with simple means and can withstand abrupt load changes of the printing plate.

The task is solved according the invention by inserts allocated to registering elements, which are contacting the printing plate electrically isolated from the registering elements and are connected to a control unit.

Advantages of the invention are especially a wear resistant and fracture-proof registering element, which can be manufactured with low costs and guarantees a secure function.

### BRIEF DESCRIPTION OF THE DRAWING

The invention is described below in greater detail by embodiments of the invention, by reference being had to the drawing, wherein:

FIG. 1: Schematic drawing of a plate cylinder with an open clamping rail during insertion of the printing plate

FIG. 2: Schematic of the register-proof position of the printing plate at the registering pins

FIG. 3 Schematic of a registering pin with a flat touching head (top view)

FIG. 4 Schematic of a registering pin with a round touching head (top view)

### DETAILED DESCRIPTION

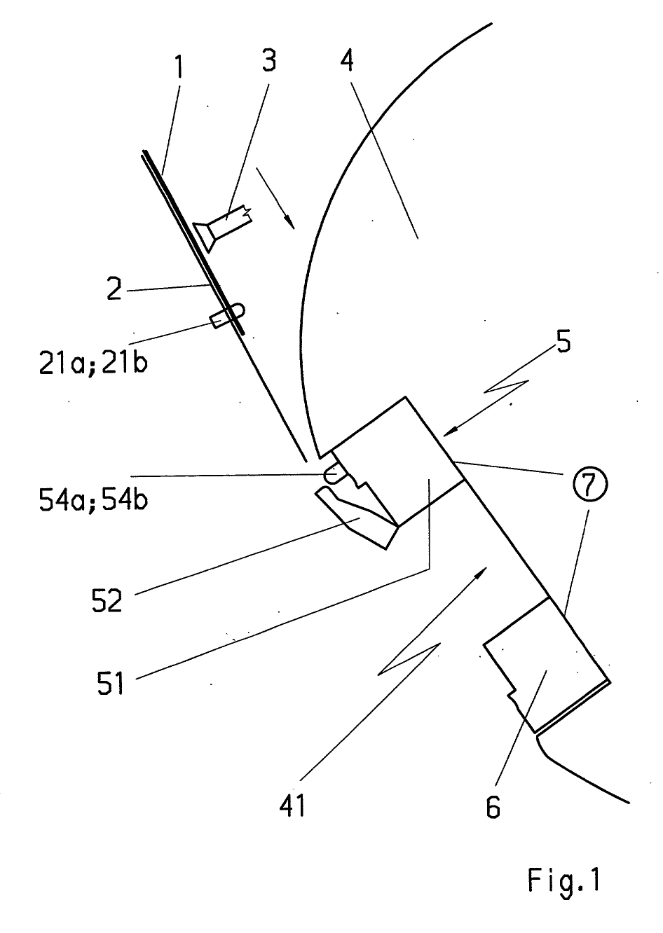

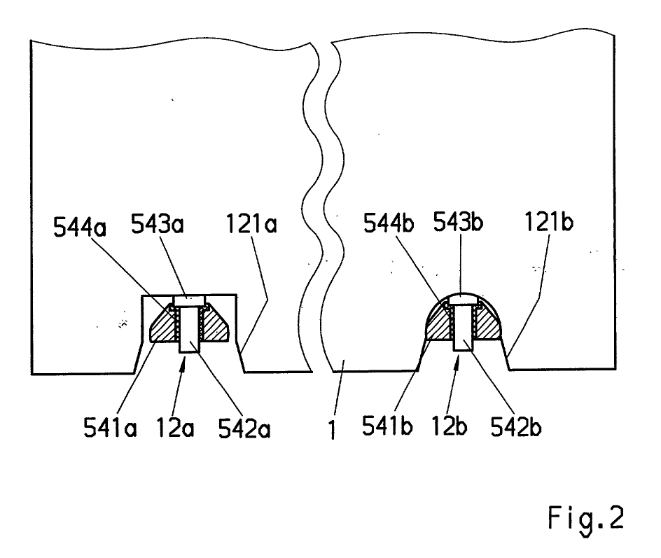

FIG. 1 shows a printing plate 1 stored in a printing plate magazine 2. The printing plate 1 rests in two pre-registering pins 21a, 21b which are corresponding to the registering punches 12a, 12b (see FIG. 2) of the printing plate. The registering pins 21a, 21b are in a certain distance to each other.

The registering punches 12a, 12b have a different shape. The registering punch 12a has a flat bottom; the registering punch 12b has a radius at the bottom (see FIG. 2). Both have the same insertion bevel 121a, 121b. The pre-registering pins 21a, 21b have an appropriate shape to the registering punch 12a, 12b. This means that a round pre-registering punch 12b fits the round pre-registering pin 21b (not shown) whereby its radius matches the radius of the registering punch 12b. The registering punch 12a takes the pre-registering pin 21a which is flat as the contact zone in the registering punch 12a in the printing plate 1. The sides of the registering punch 12a do not have contact with the pre-registering pin 21a.

The printing plate magazine 2 is in its resting position mounted to the not shown frame of the printing press.

The plate cylinder 4 is also arranged in this frame. The printing cylinder 4 carries on its surface the printing plate 1 supplied from the printing plate magazine 2 and has on its circumference a plate cylinder gap 41 stretching in axial direction. A plate clamping device 7 is located in the plate cylinder gap 4. It consists of a front clamping device 5 and a rear clamping and tensioning device 6 for the plate end. The front clamping device 5 has an upper clamping rail 52 and a lower clamping rail 51. The upper clamping rail 52 is fixed mounted at the plate cylinder gap 41. The lower clamping rail 51 can be moved against the upper clamping rail 52 for clamping of the printing plate 1.

The front clamping device 5 has registering elements embodied as registering pins 54a, 54b in the area of clamping rails 51, 52. FIG. 2 shows that the registering pins 54a, 54b are in a finite distance from each other as the pre-registering pins 21a, 21b from each other. The registering pin 54a has as the pre-registering pin 21a a flat contact area to the bottom of the registering punch 12a. The registering pin 54b has as the pre-registering pin 21b a radius to accommodate the radius of the contact area of the registering punch 12b.

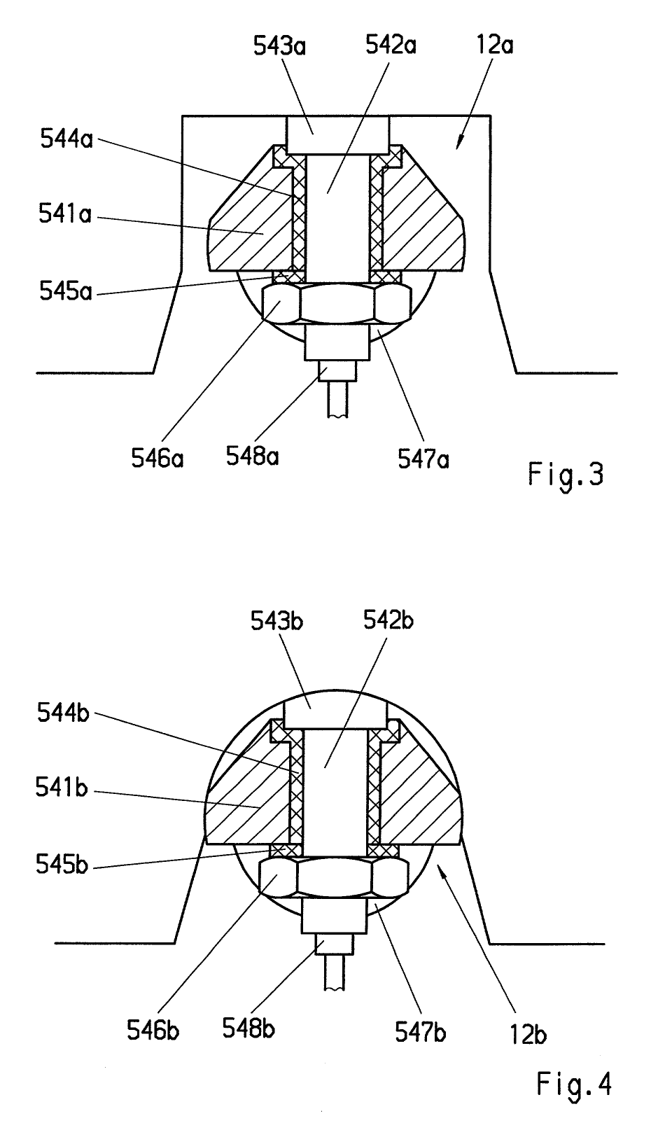

The design of the registering pins 54a, 54b is shown in FIG. 3 and FIG. 4. Both registering pins 54a, 54b have a foot 547a, 547b carrying the guiding body 541a, 541b. FIG. 3 and FIG. 4 are showing a top view in the direction of the registering pins 54a, 54b whereby FIG. 3 and FIG. 4 are a section through the guiding body 541a, 541b. Rectangular to the axis of the registering pins 54a, 54b is in transportation direction of the printing plate 1 a bore in the guiding body 541a, 541b for the insert 542a, 542b. These inserts 542a, 542b are electrically isolated to the guiding body 541a, 541b by an isolation sleeve 544a, 544b. They have an electrical connection 548a, 548b. The electrical connection 548a, 548b is connected to a not shown control unit. In the embodiment the insert 542a, 542b is fixed on the guiding body 541a, 541b by a hex nut 546a, 546b, which fastens the insert 542a, 542b via an isolating washer 545a, 545b to the guiding body 541a, 541b.

Both inserts 542a, 542b have a touching head 543a, 543b. The touching heads 543a, 543b have a different shape. The touching head 543a has a flat surface in its contact area to match the flat bottom of registering punch 12a. The touching head 543b has a contact area with a radius to accommodate the radius of registering punch 12b.

The printing plate 1 is secured in its position analogue to the positioning in printing plate magazine 2: The guiding body 542b and the touching head 543b of the registering pin 54b have contact to the registering punch 12b in the printing plate 1 and the registering punch 12a has contact at its bottom to the touching head 543a.

To the operation of apparatus:

The printing plate magazine 2 equipped with a printing plate 1 is moved from its resting position into the position for a printing plate change. The plate cylinder 4 is positioned to enable the insertion of the printing plate 1 in the front clamping device 5. FIG. 1 shows this position.

The printing plate 1 is pre-registered by the pre-registering system in the printing plate magazine 2. It is released from the printing plate magazine 2 by retracting the pre-registering pins 21a, 21b during the printing plate change. The transport device is moving the printing plate 1 for instance in the embodiment with sucker 3. Transportation by wheels or other means is also possible.

The sucker 3 gets the printing plate 1 and transports it from the printing plate magazine 2 in the direction of the opened front clamping device 5. In this position the upper clamping rail 52 is removed from the lower clamping rail 51 to the utmost distance.

The printing plate 1 with its registering punches 12a, 12b is moved inside the front clamping device 5 to the registering pins 54a, 54b. The electrical contact between the conductive printing plate 1 and the registering pins 54a and 54b is closed if the printing plate 1 reaches the registering position (see FIG. 2). An electrical signal to the printing machine control is generated when the set registering position analogue to FIG. 2 is obtained and the front clamping device 5 closes. Further steps for plate change 1 can now follow.

We claim:

1. Apparatus for correctly registering mounting of a printing plate whereby the printing plate is mounted on a plate cylinder of a sheet fed press, the plate cylinder has a plate cylinder gap with a front clamping device and rear plate clamping and tensioning device, and the front plate clamping device has registering elements connected to a control unit securing and sensing the correctly registered lateral and circumferential position in correspondence with the registering punches in the printing plate
whereby
the registering elements carrying inserts isolated to the registering elements, which are contacting the printing plate and are connected to a control unit.

2. Apparatus for correctly registering mounting of a printing plate according to claim 1
whereby
the inserts are arranged to contact the bottom area of the registering punches.

3. Apparatus for correctly registering mounting of a printing plate according to claim 1 and 2,
whereby
the inserts are carrying on the plate side end touching heads accommodating the registering punches in the bottom area.

4. Apparatus for correctly registering mounting of a printing plate according to claims 1 and 2,
whereby
the inserts have electrical connections on the turn-away side of the printing plate.
